(19) United States
(12) Patent Application Publication
(10) Pub. No.: US 2009/0259994 A1
(43) Pub. Date: Oct. 15, 2009

(54) Apparatus, Method, and Computer Program Product for Analyzing Program Memory Operations

(75) Inventor: Rami Arto Koivunen, Turku (FI)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/103,257

(22) Filed: Apr. 15, 2008

(51) Int. Cl. G06F 9/44

(52) U.S. Cl. 717/127

(57) ABSTRACT

In accordance with an example embodiment of the present invention, an apparatus, comprising a memory; and a processor configured to monitor operations of at least one program related to the memory and analyze memory operations of the at least one program based at least in part on the monitoring is disclosed.

### TECHNICAL FIELD

The present application relates generally to memory management.

### BACKGROUND

The modern era of electronic devices has seen a dramatic increase in the number of electronic devices used by individuals. These devices are experiencing an unprecedented growth in consumer demand. Many of these devices utilize electronically programmable memory which may have a reliability limited by the number of certain operations within the lifetime of the memory. For example, some electronically programmable memory devices become less reliable after performing a certain number of erase operations. The reliability of these devices may be related to the reliability of the programmable memory. For example, in such a device, if at least part of the memory becomes unreliable, the product itself may become unreliable.

Many of these devices may be capable of running more than one program which may perform operations on the programmable memory. Furthermore, many of these devices allow users to load programs onto these devices for execution. Some of these programs may perform an excessive number of memory operations which may negatively impact the reliability of a device over time. Some programs may be inadvertently designed so that these operations are performed excessively. However other programs may be specifically designed to perform excessive memory operations in order to degrade the reliability of memory.

### SUMMARY

In accordance with an example embodiment of the present invention, an apparatus, comprising a memory; and a processor configured to monitor operations of at least one program related to the memory and analyze memory operations of the at least one program based at least in part on the monitoring is disclosed.

In accordance with another example embodiment of the present invention, a method, comprising monitoring memory operations of at least one program and analyzing memory operations of the at least one program based at least in part on the monitoring is disclosed.

In accordance with another example embodiment of the present invention, a computer program product comprising a computer-readable medium bearing computer program code embodied therein for use with a computer, the computer program code comprising code for monitoring memory operations of at least one program and code for analyzing memory operations of the at least one program based at least in part on the monitoring is disclosed.

### BRIEF DESCRIPTION OF THE DRAWINGS

For a more complete understanding of example embodiments of the present invention, the objects and potential advantages thereof, reference is now made to the following descriptions taken in connection with the accompanying drawings in which:

FIG. 1 is a block diagram of an electronic device according to an example embodiment of the present invention;

FIG. 2 is a flow diagram of an example embodiment of a method for analyzing program memory operations;

FIG. 3 is a table illustrating an example embodiment of a method for analyzing program behavior;

FIG. 4 is a table illustrating another example embodiment of a method for analyzing program behavior;

FIG. 5 is a table illustrating yet another example embodiment of a method for analyzing program behavior; and

FIG. 6 is a block diagram of memory segmentation in an example embodiment.

### DETAILED DESCRIPTION OF THE DRAWINGS

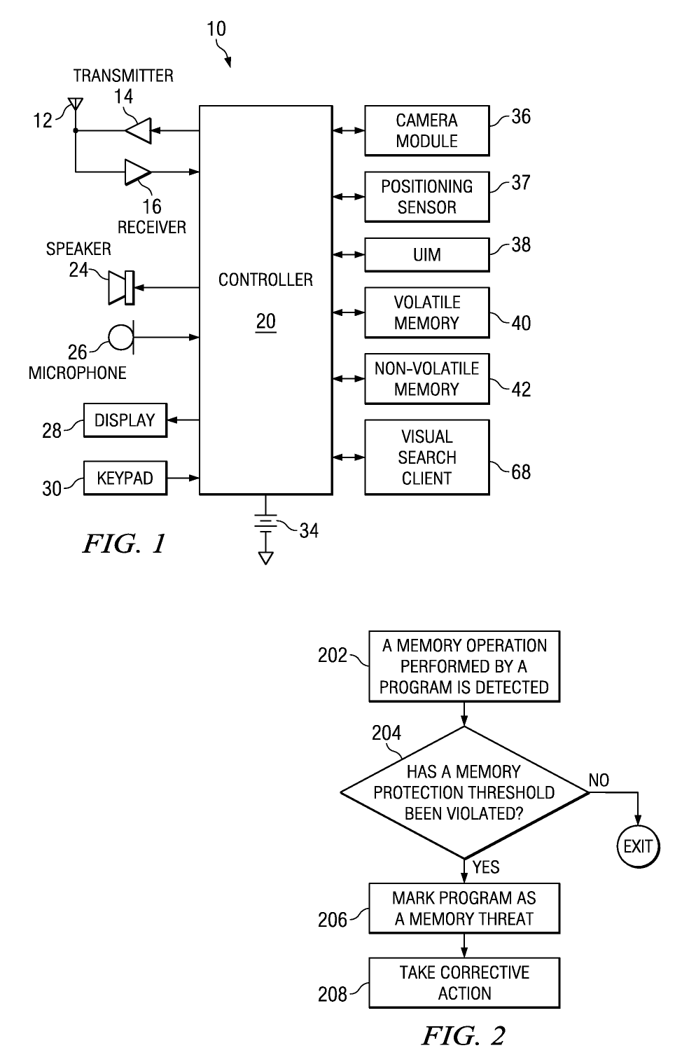

An example embodiment of the present invention and its potential advantages are best understood by referring to FIGS. 1 through 6 of the drawings, like numerals being used for like and corresponding parts of the various drawings.

Embodiments of the present invention will now be described more fully hereinafter with reference to the accompanying drawings, in which some, but not all embodiments of the invention are shown. Indeed, embodiments of the invention may be embodied in many different forms and should not be construed as limited to the embodiments set forth herein; rather, these embodiments are provided so that this disclosure will satisfy applicable legal requirements.

FIG. 1 is a block diagram of an electronic device, for example, mobile terminal 10, according to an example embodiment of the present invention. It should be understood, however, that a mobile terminal as illustrated and hereinafter described is merely illustrative of an electronic device that would benefit from embodiments of the present invention and, therefore, should not be taken to limit the scope of the present invention. While one embodiment of the mobile terminal 10 is illustrated and will be hereinafter described for purposes of example, other types of electronic devices, such as, but not limited to, portable digital assistants (PDAs), pagers, mobile computers, desktop computers, televisions, gaming devices, laptop computers, cameras, video recorders, GPS devices and other types of electronic systems, may readily employ embodiments of the present invention. Furthermore, devices may readily employ embodiments of the present invention regardless of their intent to provide mobility.

Embodiments of the present invention will be primarily described below in conjunction with mobile communications applications. However, it should be understood that embodiments of the present invention may be utilized in conjunction with a variety of other applications, both in the mobile communications industries and outside of the mobile communications industries.

The mobile terminal 10 comprises an antenna 12 (or multiple antennae) in operable communication with a transmitter 14 and a receiver 16. The mobile terminal 10 further comprises a controller 20 or other processing element that provides signals to and receives signals from the transmitter 14 and receiver 16, respectively. The signals comprise signaling information in accordance with the air interface standard of the applicable cellular system, and also user speech, received data and/or user generated data. In this regard, the mobile terminal 10 may operate with one or more air interface standards, communication protocols, modulation types, and access types. By way of illustration, the mobile terminal 10 may operate in accordance with any of a number of first, second, third and/or fourth-generation communication protocols or the like. For example, the mobile terminal 10 may operate in accordance with second-generation (2G) wireless communication protocols IS-136 (TDMA), GSM, and IS-95 (CDMA), or with third-generation (3G) wireless communication protocols, such as UMTS, CDMA2000, WCDMA and TD-SCDMA, with fourth-generation (4G) wireless communication protocols, and/or the like.

It is understood that the controller 20 comprises circuitry desirable for implementing audio and logic functions of the mobile terminal 10. For example, the controller 20 may comprise a digital signal processor device, a microprocessor device, various analog to digital converters, digital to analog converters, and for other support circuits. Control and signal processing functions of the mobile terminal 10 are allocated between these devices according to their respective capabilities. The controller 20 thus may also comprise the functionality to convolutionally encode and interleave message and data prior to modulation and transmission. The controller 20 may additionally comprise an internal voice coder, and may comprise an internal data modem. Further, the controller 20 may comprise functionality to operate one or more software programs, which may be stored in memory. For example, the controller 20 may operate a connectivity program, such as a conventional Web browser. The connectivity program may then allow the mobile terminal 10 to transmit and receive Web content, such as location-based content and/or other web page content, according to a Wireless Application Protocol (WAP), Hypertext Transfer Protocol (HTTP), and/or the like, for example.

The mobile terminal 10 may also comprise a user interface including an output device such as a ringer, a conventional earphone and/or speaker 24, a microphone 26, a display 28, and/or a user input interface, which are coupled to the controller 20. The user input interface, which allows the mobile terminal 10 to receive data, may comprise any of a number of devices allowing the mobile terminal 10 to receive data, such as a keypad 30, a touch display (not shown) or other input device. In embodiments including the keypad 30, the keypad 30 may comprise the conventional numeric (0-9) and related keys (#, *), and other keys used for operating the mobile terminal 10. Alternatively, the keypad 30 may comprise a conventional QWERTY keypad arrangement. The keypad 30 may also comprise various soft keys with associated functions. In addition, or alternatively, the mobile terminal 10 may comprise an interface device such as a joystick or other user input interface. The mobile terminal 10 further comprises a battery 34, such as a vibrating battery pack, for powering various circuits that are required to operate the mobile terminal 10, as well as optionally providing mechanical vibration as a detectable output.

In an example embodiment, the mobile terminal 10 comprises a media capturing element, such as a camera, video and/or audio module, in communication with the controller 20. The media capturing element may be any means for capturing an image, video and/or audio for storage, display or transmission. For example, in an example embodiment in which the media capturing element is a camera module 36, the camera module 36 may comprise a digital camera which may form a digital image file from a captured image. As such, the camera module 36 comprises hardware, such as a lens or other optical component(s), and/or software necessary for creating a digital image file from a captured image. Alternatively, the camera module 36 may comprise only the hardware for viewing an image, while a memory device of the mobile terminal 10 stores instructions for execution by the controller 20 in the form of software for creating a digital image file from a captured image. In an example embodiment, the camera module 36 may further comprise a processing element such as a co-processor which assists the controller 20 in processing image data and an encoder and/or decoder for compressing and/or decompressing image data. The encoder and/or decoder may encode and/or decode according to a standard format, for example, a JPEG standard format.

The mobile terminal 10 may further comprise a user identity module (UIM) 38. The UIM 38 may be a memory device having a built in processor. The UIM 38 may comprise, for example, a subscriber identity module (SIM), a universal integrated circuit card (UICC), a universal subscriber identity module (USIM), a removable user identity module (R-UIM), and/or the like. The UIM 38 may store information elements related to a mobile subscriber. In addition to the UIM 38, the mobile terminal 10 may be equipped with memory. For example, the mobile terminal 10 may comprise volatile memory 40, such as volatile Random Access Memory (RAM) including a cache area for the temporary storage of data. The mobile terminal 10 may also comprise other memory, for example, non-volatile memory 42, which may be embedded and/or may be removable. The non-volatile memory 42 may additionally or alternatively comprise an EEPROM, flash memory or the like, such as that available from the SanDisk Corporation of Sunnyvale, Calif., or Lexar Media Inc. of Fremont, Calif. The memories may store any of a number of pieces of information, and data. The information and data may be used by the mobile terminal 10 to implement the functions of the mobile terminal 10. For example, the memories may comprise an identifier, such as an international mobile equipment identification (IMEI) code, which may uniquely identify the mobile terminal 10.

Although FIG. 1 illustrates an example of a mobile terminal which may utilize embodiments of the present invention, it should be understood that the mobile terminal 10 of FIG. 1 is merely an example device that may utilize embodiments of the present invention. Generally speaking, any device having a processing element for managing memory operations may utilize embodiments of the present invention. In this regard, for example, such a device may also comprise or otherwise be in communication with a memory device and may also comprise some form of user interface. For example, such devices could be, but are not limited to, portable digital assistants (PDAs), pagers, mobile computers, desktop computers, televisions, gaming devices, laptop computers, cameras, video recorders, GPS devices and other types of electronic systems. A processing element such as those described above may be embodied in many ways. For example, the processing element may be embodied as a processor, a coprocessor, a controller or various other processing means or devices including integrated circuits such as, for example, an ASIC (application specific integrated circuit), FPGA (field programmable gate array), and/or the like.

The memory, for example non-volatile memory 42, may comprise a memory which exhibits a reliable lifetime limited by a number of one or more types of operations. For example the storage unit of a type of flash memory may be reliable until 100,000 erases have been performed. It should be understood that there are various factors that may contribute at least in part to the number of operations which may be performed before reliability is noticeably impacted. For example, one flash memory device may be reliable until 2000 erase operations, while another flash memory device may be reliable until 50,000 erase operations. A device, for example mobile terminal 10, may have its reliable lifetime directly related to the reliable lifetime of the non-volatile memory 42. Therefore, it may be desirable to monitor and/or control operations performed on a memory in a way that reduces the impact of operations which may reduce the reliable lifetime of the memory.

The memory, for example non-volatile memory 42, may store programs and/or data used by programs. In some devices, for example mobile terminal 10 of FIG. 1, it may be possible for a user to install a program which was not initially installed in the device. The memory may be used by this program. In addition, a program which may be installed on the device may be developed outside of the control of the manufacturer of the device. Therefore, it may be desirable to monitor and/or control the operations performed by programs to guard against memory usage which may adversely impact the reliable lifetime of a device. It may be desirable to analyze memory operations by a program or set of programs. It may be desirable to base control of memory operations at least in part on the analysis of a program or set of programs.

FIG. 2 is a flow diagram of an example embodiment of a method for analyzing program memory operations. It should be understood, however, that the memory analyzing method of FIG. 2 as illustrated and hereinafter described is merely illustrative of a memory monitoring method which may be employed to monitor and/or control memory operations, and therefore, should not be taken to limit the scope of the present invention.

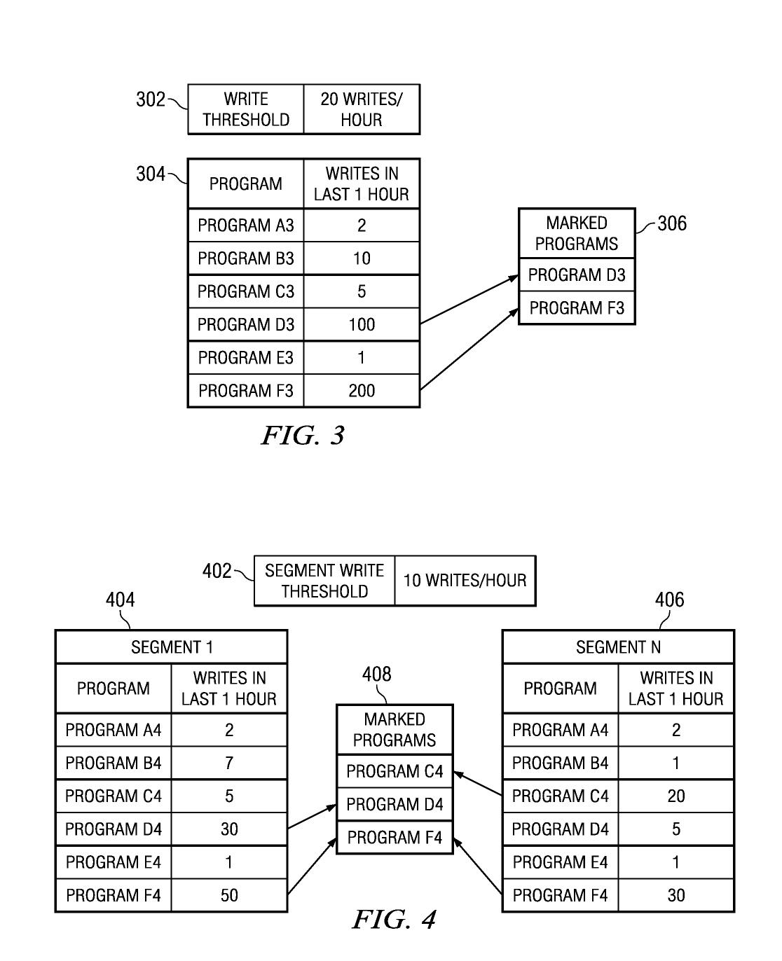

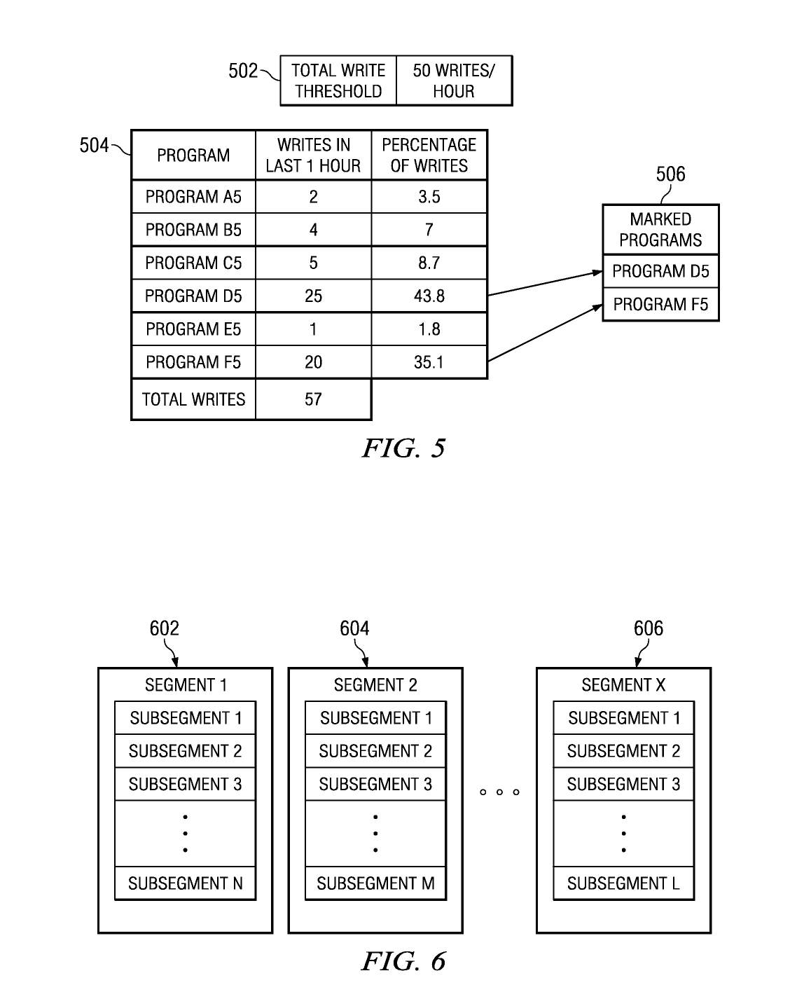

In an example embodiment, at block 202, a memory operation performed by a program is detected. It should be understood that a program may comprise at least a partial set of instructions to perform a task. For example a program may be a software application, such as a game, web browser, and/or the like. In another example, a program may be a software library component such as a dynamically linked library, a utility, a codec, and/or the like. The memory operation may be an erase operation, a write operation, and/or the like. At block 204, it is determined whether a memory protection threshold has been violated, for example, the write threshold 302 of FIG. 3, the block write threshold 402 of FIG. 4, the set write threshold 502 of FIG. 5, and/or the like. It should be understood that a memory protection threshold may be predetermined, dynamically calculated, and/or the like. For example, when using some memory management methods it may be desirable to lower the write operation thresholds in relation to the reduction of free space in the memory. These example thresholds will be discussed hereinafter in conjunction with the description of the respective example thresholds. If, at block 204 it is determined that a memory protection threshold has not been violated, the flow may exit. It should be understood that if another memory operation performed by a program is detected, the flow may enter block 202. If, at block 204 it is determined that a memory protection threshold has been violated, the program may be marked at block 206 to indicate that the program may be a memory threat. It should be understood that at block 206 more than one program may be marked. For example, if a significant contribution criterion is used, as related to FIG. 5, the programs significantly contributing to the memory threshold violation may be marked. It should be understood that there may be multiple thresholds of the same type which may identify more than one level of threat to memory reliability. For example, a write threshold of one value may indicate a minor threat to memory, while a write threshold of another value may indicate a major threat to memory. It should also be understood that there may be different thresholds related to different programs. For example, one program may have a write operation threshold of one value while another program may have a write operation threshold of another value. It should be understood that there may be more than one marking for a program. For example, it may be desirable to differentiate between a marking resulting from one memory operation threshold violation and a marking resulting from another memory threshold violation.

At block 208, corrective action is taken related to the marked program of block 206. The corrective action may comprise actions impacting the usage of the program, impacting the usage of the device, notifying a user or authority, and/or the like. Corrective action may be performed individually, in conjunction with another corrective action, and/or in a progressive succession of corrective actions.

In an example embodiment, at block 208, notification may be generated that one or more programs have violated a memory usage threshold. The notification may be given to the user, the device manufacturer, an authority, such as a software security organization, and/or the like. In addition, the notification may be stored and may be retrieved at a later time. The notification may be performed when the threshold is violated, when the program is launched, periodically, such as during the running of a program, and/or the like. It should be understood that a query may be utilized in addition to or instead of a notification. For example, it may be desirable to query a monitoring program to determine if a threshold has been violated.

In another example embodiment, at block 208, the memory operation may be modified. For example, if a program is attempting to erase and write data to a memory location, the data may be written to a different memory location. This different memory location may be part of the same memory and/or one or more different memories. For example, the write operation may be performed in volatile memory instead of non-volatile memory. It may be desirable to prevent at least part of the memory operation from being performed. For example, the program may be prevented from performing any erase or write operations on at least part of the non-volatile memory.

In yet another example embodiment, at block 208, the marked program may be uninstalled. For example, if a program exceeds a threshold related to a number of memory write operations, it may be marked and uninstalled from the device with or without user confirmation.

In still another example embodiment, at block 208, a program may be notified of the marked program. For example, a security program may receive notification that a program has violated a threshold.

It should be understood that at least partial basis of corrective action may comprise type of threshold violated, type of program, and/or the like. It should be understood that one or more corrective actions may be taken. Furthermore, there may be different corrective actions associated with different thresholds, different values of the same threshold, and/or the like. For example, if a program is marked as a significant contributor to a write threshold, such as program F5 of FIG. 5, a user notification may be performed, while a program violating a block write threshold, such as program F4 of FIG. 4, a notification may be sent to the manufacturer and the program may be prevented from at least some memory operations. In another example, if a program violates a write threshold of one value, a user notification may occur, while if a program violates a write threshold of another value, a manufacturer notification may occur, while if a program violates a write threshold of yet another value, the program may be uninstalled. It should also be understood that corrective action may be related to the type of program performing a memory operation. For example, a program created by a device manufacturer which violates a memory threshold may have a different corrective action than a program loaded from an unknown vendor from the internet which violates the same memory threshold.

In an example embodiment, it may be desirable to monitor memory operations of one or more programs over a time interval/period to detect potentially harmful memory usage patterns related to excessive operations. It should be understood that a time interval/period may be predetermined, dynamically calculated, and/or the like.

FIG. 3 is a table illustrating an example embodiment of a method for analyzing program behavior in memory operations per time interval/period. It should be understood, however, that the program analysis method of FIG. 3 as illustrated and hereinafter described is merely illustrative of a method for program analysis which may be employed to analyze and/or control memory operations, and therefore, should not be taken to limit the scope of the present invention.

In the example embodiment of FIG. 3, a program analysis method may monitor memory utilization patterns, for example the number of writes to at least a portion of memory. It should be understood that the memory utilization analysis may relate to non-volatile memory, for example non-volatile memory 42 of FIG. 1, and/or other memory. It should be further understood that the memory utilization analysis may relate to memory operations performed on a part of or the whole of the memory of the electronic device. In an example embodiment, one or more programs that utilize memory may be monitored relating to the number of write operations performed over a time interval, for example 1 hour. It should be understood that an interval of 1 hour is merely an example, and that it may be desirable to use smaller and/or larger intervals. It should also be understood that multiple intervals may be monitored simultaneously. The measurement of the memory write operations over the interval may be performed by measuring the number of memory write operations every interval as they occur, measuring the number of memory write operations that have occurred during the last interval, and/or the like. It should be further understood that measurement of memory operations may be performed without a time interval. For example, measurement may be performed on the total number of memory write operations by a program.

Table 304 of FIG. 3 illustrates an example of the number of write operations performed by a plurality of programs in a 1 hour interval. Table 304 illustrates a program A3 which has performed 2 write operations in the last 1 hour period, program B3 which has performed 10 write operations in the last 1 hour period, program C3 which has performed 5 write operations in the last 1 hour period, program D3 which has performed 100 write operations in the last 1 hour period, program E3 which has performed 1 write operation in the last 1 hour period, and program F3 which has performed 200 write operations in the last 1 hour period. In an example embodiment, a write threshold may relate to a number of write operations over a given period of time which may indicate that marking a program for corrective action may be desirable. In the example of FIG. 3, table 302 illustrates a write threshold of 20 writes per hour. It should be understood that this threshold value is merely an example and that it may be desirable to set a write threshold higher than 20 writes per hour and/or lower than 20 writes per hour. Table 306 illustrates the programs that may be marked for corrective action based at least in part on the illustrated write threshold of 20 writes per hour. It can be seen in this example that program D3 and program F3 have exceeded the write threshold based at least in part on the illustrated write threshold of 20 writes per hour, and have been marked for corrective action.

In an example embodiment, it may be desirable to monitor memory operations performed on one or more segments of memory by one or more programs over a given time to detect potentially harmful memory usage patterns related to excessive operations.

FIG. 4 is a table illustrating an example embodiment of a method for analyzing program behavior based at least in part on memory operations within at least one segment of memory per time interval/period. It should be understood, however, that the program analysis method of FIG. 4 as illustrated and hereinafter described is merely illustrative of a program analysis method which may be employed to analyze and/or control memory operations, and therefore, should not be taken to limit the scope of the present invention.

In the example embodiment of FIG. 4, a program analysis method may monitor memory segment, for example memory segment 1 at 602 of FIG. 6, utilization patterns, for example the number of write operations to at least a portion of memory. It should be understood that the memory segment utilization analysis may relate to non-volatile memory, for example non-volatile memory 42 of FIG. 1, and/or other memory. It should also be understood that, although a memory segment is used in this example, this method may relate to any section, subsection, and/or the like of memory. For example, a subsegment, for example subsegment 1 of segment 1 of FIG. 6, may be used. It should be further understood that memory segment monitoring may relate to one or more segments of memory. In an example embodiment, one or more programs which may utilize one or more segments of memory may be monitored relating to the number of writes performed over a time interval, for example 1 hour for a related segment, for example segment 1. It should be understood that an interval of 1 hour is merely an example, and that it may be desirable to use smaller and/or larger intervals. It should also be understood that multiple intervals may be monitored simultaneously. The measurement of the memory write operations over the interval may be performed by measuring the number of memory write operations every interval as they occur, measuring the number of memory write operations that have occurred during the last interval, and/or the like. It should be further understood that measurement of memory operations related to a memory segment may be performed without a time interval. For example, measurement may be performed on the total number of memory write operations related to a memory segment by a program.

Table 404 of FIG. 4 illustrates an example of the number of write operations performed on an example segment, say segment 1, by at least one program within a 1 hour interval. Table 404 illustrates a program A4 which has performed 2 write operations on segment 1 in the last 1 hour period, program B4 which has performed 7 write operations on segment 1 in the last 1 hour period, program C4 which has performed 5 write operations on segment 1 in the last 1 hour period, program D4 which has performed 30 write operations on segment 1 in the last 1 hour period, program E4 which has performed 1 write operation on segment 1 in the last 1 hour period, and program F4 which has performed 50 write operations on segment 1 in the last 1 hour period. Table 406 illustrates an example of the number of write operations performed on an example segment, segment N, by at least one program within a 1 hour interval. Table 406 illustrates program A4 which has performed 2 write operations on segment N in the last 1 hour period, program B4 which has performed 1 write operations on segment N in the last 1 hour period, program C4 which has performed 20 write operations on segment N in the last 1 hour period, program D4 which has performed 5 write operations on segment N in the last 1 hour period, program E4 which has performed 1 write operation on segment N in the last 1 hour period, and program F4 which has performed 30 write operations on segment N in the last 1 hour period.

In an example embodiment, a segment write threshold may relate to a number of write operations over a given period of time to a segment of memory which may indicate marking a program for corrective action may be desirable. In the example of FIG. 4, table 402 illustrates a segment write threshold of 10 writes per hour. It should be understood that this threshold value is merely an example and that it may be desirable to set a segment write threshold higher than 10 writes per hour and/or lower than 10 writes per hour. Table 408 illustrates the programs that may be marked for corrective action. It can be seen in this example that program C4, program D4, and program F4 have exceeded the segment write threshold of 10 writes in the last hour in at least one monitored segment, and have been marked for corrective action.

In another example embodiment, it may be desirable to monitor the memory operations of one or more programs in relation to each other. It should be understood that one or more programs may be monitored together and/or in sets. In an example embodiment, when more than one program are monitored together in a set, then one or more programs in the set may be marked for corrective action, it together the programs in the set exceed the thresholds. There may be different criteria relating to which programs may be desirable to monitor as a set. For example, it may be desirable to monitor all programs in a set. In another example, it may be desirable to monitor programs loaded by the user in a set. In yet another example, it may be desirable to monitor programs preloaded on a device in a set. It should be understood that there may be one or more sets of programs monitored. It should be further understood that a program may be monitored in one or more than one sets of programs.

In an example embodiment, it may be desirable to monitor memory operations by one or more sets of programs over a given time to detect potentially harmful memory usage patterns related to excessive operations by a set of programs. In such cases, when the programs in the set together exceed a threshold, then more than one program may be marked for corrective action. It may also be desirable to determine which programs significantly contribute to the number of monitored memory operations. It should be understood that there may be various statistical methods which may be used to determine the significant contribution of a program towards a number of memory operations, such as calculating mean, median, variance, and/or the like.

FIG. 5 is a table illustrating an example embodiment of a method for analyzing program behavior based at least in part on a set of programs in memory operations per time interval/period. It should be understood, however, that the program analysis method of FIG. 5 as illustrated and hereinafter described is merely illustrative of a program set analysis method which may be employed to analyze and/or control memory operations, and therefore, should not be taken to limit the scope of the present invention.

In the example embodiment of FIG. 5, a program set analysis method may monitor memory utilization patterns of a set of programs, for example the number of writes to at least a portion of memory. It should be understood that the memory utilization analysis may relate to non-volatile memory, for example non-volatile memory 42, and/or other memory. In an example embodiment, one or more programs in a set of programs that utilize memory may be monitored relating to the number of write operations performed over a time interval, for example 1 hour. It should be understood that an interval of 1 hour is merely an example, and that it may be desirable to use smaller and/or larger intervals. It should also be understood that multiple intervals may be monitored simultaneously. The measurement of the memory write operations over the interval may be performed by measuring the number of memory write operations every interval as they occur, measuring the number of memory write operations that have occurred during the last interval, and/or the like. It should be further understood that measurement of memory operations of a program in relation to memory operations of a set of programs may be performed without a time interval. For example, measurement may be performed on the total number of memory write operations of a program in relation to memory write operations of a set of programs.

Table 504 of FIG. 5 illustrates an example of the number of write operations performed by programs within a 1 hour interval and the percentage of write operations performed by programs with respect to their respective program set. Table 504 illustrates a program A5 which has performed 2 write operations in the last 1 hour period and is approximately 3.5% of the write operations for this program set, program B5 which has performed 4 write operations in the last 1 hour period and is approximately 3.7% of the write operations for this program set, program C5 which has performed 5 write operations in the last 1 hour period and is approximately 8.7% of the write operations for this program set, program D5 which has performed 25 write operations in the last 1 hour period and is approximately 43.8% of the write operations for this program set, program E5 which has performed 1 write operation in the last 1 hour period and is approximately 1.8% of the write operations for this program set, and program F5 which has performed 20 write operations in the last 1 hour period and is approximately 35.1% of the write operations for this program set. In an example embodiment, a set total write threshold may relate to a number of write operations over a given period of time. The set total write threshold may indicate that marking one or more programs that significantly contribute to exceeding the threshold for corrective action may be desirable. In the example of FIG. 5, table 502 illustrates a set total write threshold of 50 writes per hour. It should be understood that this threshold value is merely an example and that it may be desirable for a total write threshold to be higher than 50 writes per hour and/or lower than 50 writes per hour. It should be further understood that a set write threshold may vary depending on the number of programs that comprise the program set. It can be seen that in the example of FIG. 5 that the total number of write operations of the program set violates the set total write threshold. Table 506 illustrates the programs that may be marked for corrective action. It can be seen in this example that program D5 and program F5 have a significantly higher percentage of write operations within the last hour. Program D5 and program F5 may be marked based at least in part on significant contribution to exceeding the total write threshold. It should be understood that there may be varying statistical methods utilized to determine which programs may be marked for corrective action. For example, it may be desirable to mark a program for corrective action based at least in part on whether has exceeded the mean program writes by one standard deviation. In another example, it may be desirable to mark a program for corrective action based at least in part on whether it has exceeded an individual program write threshold.

FIG. 6 is a block diagram of memory segmentation in an example embodiment. It should be understood, however, that the memory segmentation of FIG. 6 as illustrated and hereinafter described is merely illustrative of a memory segmentation which may be employed, and therefore, should not be taken to limit the scope of the present invention.

FIG. 6 illustrates an example memory segmentation which divides a memory into one or more memory segments. Each memory segment may be further divided into one or more memory subsegments. In the example of FIG. 6, memory is segmented into memory segments 1 through X as illustrated by 602, 604, and 606. Block 602, denoting memory segment 1, may be divided into N memory subsegments. Block 604, denoting memory segment 2, may be divided into M memory subsegments. Block 606, denoting memory segment X, may be divided into L memory subsegments. It should be understood that the subsegments in consecutive segments may be adjacently located. For example, memory subsegment 1 of segment 2 may be adjacent to memory subsegment N of segment 1. It should be understood that the number of memory subsegments may vary by memory segment. For example memory segment 1 may be divided into 3 memory subsegments, while memory segment X may be divided into 5 memory subsegments. It should be understood that the terminology of segments and subsegments is used as a generalization of any memory segmentation. For example, this diagram may describe at least part of the relationships between sectors, pages, blocks, partitions, and/or the like.

Embodiments of the present invention may be implemented in software, hardware, application logic or a combination of software, hardware and application logic. The software, application logic and/or hardware may reside on a memory device, and/or a programmable device. If desired, part of the software, application logic and/or hardware may reside on a memory device and part of the software, application logic and/or hardware may reside on a programmable device. The application logic, software or an instruction set is preferably maintained on any one of various conventional computer-readable media. In the context of this document, a “computer-readable medium” can be any media or means that can contain, store, communicate, propagate or transport the instructions for use by or in connection with an instruction execution system, apparatus, or device.

If desired, the different functions discussed herein may be performed in any order and/or concurrently with each other. Furthermore, if desired, one or more of the above-described functions may be optional or may be combined.

Without in any way limiting the scope, interpretation, or application of the claims appearing below, it is possible that a technical advantage of one or more of the example embodiments disclosed herein may be monitoring and/or controlling of program memory operations. Another possible technical advantage of one or more of the example embodiments disclosed herein may be identifying programs which may negatively impact a memory reliable lifetime. Yet another possible technical advantage of one or more of the example embodiments disclosed herein may be taking action related to a program and its memory operations. Still another possible technical advantage of one or more example embodiments disclosed herein may be analyzing memory operations by a program or set of programs

Although various aspects of the invention are set out in the independent claims, other aspects of the invention comprise any combination of features from the described embodiments and/or the dependent claims with the features of the independent claims, and not solely the combinations explicitly set out in the claims.

It is also noted herein that while the above describes exemplifying embodiments of the invention, these descriptions should not be viewed in a limiting sense. Rather, there are several variations and modifications which may be made without departing from the scope of the present invention as defined in the appended claims.

What is claimed is:

1. An apparatus, comprising:
a memory; and
a processor configured to monitor operations of at least one program related to said memory and analyze memory operations of said at least one program based at least in part on said monitoring.

2. The apparatus of claim 1, wherein said processor configured to monitor operations comprises:
said processor configured to measure memory operations.

3. The apparatus of claim 1, wherein said processor configured to monitor operations comprises:
said processor configured to measure memory operations over a time interval.

4. The apparatus of claim 1, wherein said processor configured to monitor operations comprises:
said processor configured to measure memory operations of said at least one program in relation to memory operations of a set of programs.

5. The apparatus of claim 1, wherein said processor is further configured to:
perform a corrective action based at least in part on said analyzing.

6. The apparatus of claim 5, wherein said processor configured to perform corrective action comprises:
said processor configured to generate a user notification related to said analysis.

7. The apparatus of claim 5, wherein said processor configured to perform corrective action comprises:
said processor configured to restrict memory operations of said at least one program.

8. The apparatus of claim 5, wherein said processor configured to perform corrective action comprises:
said processor configured to store a notification related to said analysis.

9. A method, comprising:
monitoring memory operations of at least one program; and
analyzing memory operations of said at least one program based at least in part on said monitoring.

10. The method of claim 9, wherein said monitoring comprises:
measuring memory operations.

11. The method of claim 9, wherein said monitoring comprises:
measuring memory operations over a time interval.

12. The method of claim 9, wherein said monitoring comprises:
measuring memory operations of at least one program in relation to memory operations of a set of programs.

13. The method of claim 9, further comprising:
performing a corrective action based at least in part on said analyzing.

14. The method of claim 13, wherein said corrective action comprises:
generating a user notification related to said analysis.

15. The method of claim 13, wherein said corrective action comprises:
restricting memory operations of said at least one program.

16. The method of claim 13, wherein said corrective action comprises:
storing a notification related to said analysis.

17. A computer program product comprising a computer-readable medium bearing computer program code embodied therein for use with a computer, the computer program code comprising:
code for monitoring memory operations of at least one program; and
code for analyzing memory operations of said at least one program based at least in part on said monitoring.

18. The computer program product of claim 17, wherein said code for monitoring comprises:
code for measuring memory operations.

19. The computer program product of claim 17, wherein said code for monitoring comprises:
code for measuring memory operations over a time interval.

20. The computer program product of claim 17, wherein said code for monitoring comprises:
code for measuring memory operations of at least one program in relation to memory operations of a set of programs.

21. The computer program product of claim 17, further comprising:
code for performing a corrective action based at least in part on said analyzing.

22. The computer program product of claim 21, wherein said corrective action comprises:
generating a user notification related to said analysis.

23. The computer program product of claim 21, wherein said corrective action comprises:
restricting memory operations of said at least one program.

24. The computer program product of claim 21, wherein said corrective action comprises:
storing a notification related to said analysis.
